(19) United States
(12) Patent Application Publication
(10) Pub. No.: US 2020/0234317 A1
(43) Pub. Date: Jul. 23, 2020

(54) USER ACTIVITY INTEGRATED SURVEY ANALYSIS

(71) Applicant: International Business Machines Corporation, Armonk, NY (US)

(72) Inventors: Damodara VEMULA, VISAKHAPATNAM (IN); Kamal Kiran Trood YAMALA, VISAKHAPATNAM (IN); Sri Harsha VARADA, Vizianagaram (IN); Kiranmai Devi JONNALAGADDA, Visakhapatnam (IN)

(21) Appl. No.: 16/252,637

(22) Filed: Jan. 20, 2019

(51) Int. Cl. G06Q 30/02; G06F 16/2457

(52) U.S. Cl. CPC G06Q 30/0203; G06F 16/24578

(57) ABSTRACT

Embodiments generally relate to conducting and analyzing electronic surveys. In some embodiments, a method includes determining activity information associated with a first user. The method further includes providing a survey to the first user, wherein the first user is a survey participant, and wherein the survey includes the plurality of survey questions for the first user to answer. The method further includes receiving a plurality of survey answers from the first user, wherein the plurality of survey answers is responsive to the plurality of survey questions. The method further includes determining a sentiment score based at least in part on the plurality of survey answers provided by the first user. The method further includes associating the activity information with the sentiment score. The method further includes generating a recommendation for a second user based at least in part on the activity information and the sentiment score.

### BACKGROUND

Technological advances have increased the use of electronic or online surveys. A company may use an electronic survey to understand what survey participants think about the company and/or its products, for example. Surveys results may be presented in one or more graphs or other presentation forms for analysis. Surveys tend to be superficial due to the type of survey questions, which are often multiple-choice questions. On the other hand, surveys may contain survey questions that are complex or vague, which may result in a survey participant not understanding some survey questions.

### SUMMARY

Disclosed herein is a method for conducting and analyzing an electronic survey, and system and computer program product as specified in the independent claims. Embodiments are given in the dependent claims. Embodiments can be freely combined with each other if they are not mutually exclusive.

In an embodiment, a method includes determining activity information associated with a first user. The method further includes providing a survey to the first user, where the first user is a survey participant, and where the survey includes the plurality of survey questions for the first user to answer. The method further includes receiving a plurality of survey answers from the first user, where the plurality of survey answers is responsive to the plurality of survey questions. The method further includes determining a sentiment score based at least in part on the plurality of survey answers provided by the first user. The method further includes associating the activity information with the sentiment score. The method further includes generating a recommendation for a second user based at least in part on the activity information and the sentiment score.

In another embodiment, the activity information includes training classes. In another aspect, the at least one processor further performs operations including determining at least some of the activity information based at least in part on one or more data sources. In another aspect, the at least one processor further performs operations including: determining at least some of the activity information based at least in part on one or more data sources, where the activity information includes activity patterns associated with the first user; and generating the one or more survey questions based at least in part on the activity patterns associated with the first user. In another aspect, the at least one processor further performs operations including determining at least some of the activity information based on the survey. In another aspect, the at least one processor further performs operations including: determining activity information from one or more data sources, where the activity information includes activity patterns from a group of users, and where the first user belongs to the group of users; and generating the recommendation based at least in part on the activity patterns of the group of users and the survey answers. In another aspect, the at least one processor further performs operations including: receiving user feedback from the first user, where the user feedback is associated with one or more of the survey questions; and providing clarifying information to the first user based on the user feedback.

### BRIEF DESCRIPTION OF THE DRAWINGS

FIG. 1 is a block diagram of an example environment for conducting and analyzing surveys, which may be used for embodiments described herein.

FIG. 2 is an example flow diagram for conducting and analyzing surveys, according to some embodiments.

FIG. 3 is an example flow diagram for generating a recommendation based on survey results, according to some embodiments.

FIG. 4 is an example flow diagram for improving a survey taking experience, according to some embodiments.

FIG. 5 is a block diagram of an example computer system, which may be used for embodiments described herein.

### DETAILED DESCRIPTION

Embodiments described herein facilitate the conducting and analyzing of surveys. As described in more detail herein, embodiments provide surveys to survey participants, where the surveys are relevant to activities in which survey participants have participated. Embodiments also provide deep analysis of surveys by correlating survey answers to particular activity patterns of survey participants.

As described in more detail herein, in various embodiments, a system determines activity information associated with a first user, who is a survey participant or respondent user. The system generates survey questions based on the activity information, and then provides to the first user a survey with survey questions. In various embodiments, the system determines one or more sentiment scores from the survey answers, where sentiment scores may indicate a survey participants satisfaction or sentiment toward a company, management, an activity, etc. The system correlates sentiment scores with the activity information. For example, the system may determine that a first group of survey participants who receive regular training classes have higher sentiment scores than a second group of survey participants who do not receive regular training classes. The system then generates one or more recommendations for a non-respondent user based on the activity information and sentiment scores. The non-respondent user is not a survey participant, but rather a person who designs the survey or a decision-making user who makes decisions based on survey results. Such decisions may involve or affect survey participants. An example recommend might include providing the second group of survey participants with opportunities to take training classes in order to increase their overall sentiment scores (e.g., job satisfaction).

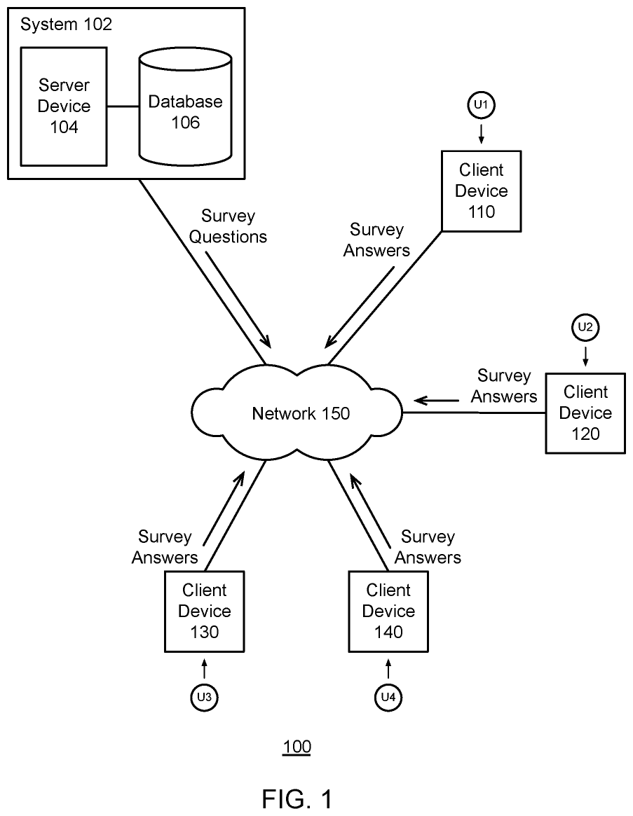

FIG. 1 is a block diagram of an example environment 100 for conducting and analyzing surveys, which may be used for embodiments described herein. In some implementations, environment 100 includes a system 102, which includes a server device 104 and a database 106. Environment 100 also includes client devices 110, 120, 130, and 140, which may communicate with system 102 and/or may communicate with each other directly or via system 102. Environment 100 also includes a network 150 through which system 102 and client devices 110, 120, 130, and 140 communicate.

As described in more detail herein, system 102 generates survey questions for surveys based on activity information associated with survey participants/respondents. System 102 sends the survey questions to the survey participants (e.g., users U1, U2, U3, U4, etc.) via respective client devices 110, 120, 130, and 140. System 102 receives survey answers in response to the survey questions from users U1, U2, U3, U4, via respective client devices 110, 120, 130, and 140. System 102 then analyzes the survey results in order to make recommendations to other users, typically decision makers such as managers, etc. Further embodiments directed to the generation and conducting of the surveys are described in more detail herein.

For ease of illustration, FIG. 1 shows one block for each of system 102, server device 104, and database 106, and shows four blocks for client devices 110, 120, 130, and 140. Blocks 102, 104, and 106 may represent multiple systems, server devices, and databases. Also, there may be any number of client devices. In other implementations, environment 100 may not have all of the components shown and/or may have other elements including other types of elements instead of, or in addition to, those shown herein.

While server 104 of system 102 performs embodiments described herein, in other embodiments, any suitable component or combination of components associated with server 102 or any suitable processor or processors associated with server 102 may facilitate performing the embodiments described herein.

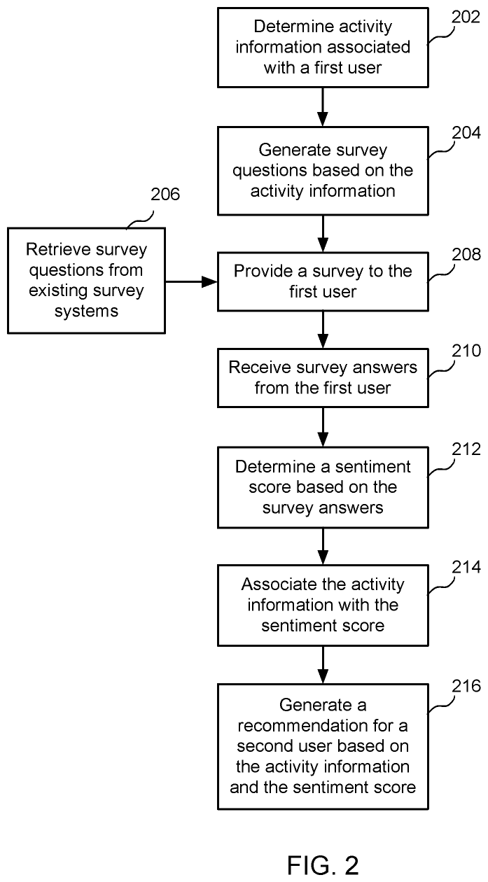

FIG. 2 is an example flow diagram for conducting and analyzing surveys, according to some embodiments. For ease of illustration, some embodiments are described herein in the context of a single user/survey participant. Note that these embodiments also apply to multiple users, or each survey participant, of a group of users. Referring to both FIGS. 1 and 2, a method begins at block 202, where a system such as system 102 determines activity information associated with a first user.

In the following example embodiments, the first user is a survey participant or respondent who takes the survey and provides survey answers responsive to survey questions. The terms survey participant and respondent may be used interchangeably. In various embodiments, the activity information may include any activities in which the first user has participated. Embodiments described herein also refer to a second user who is not a survey participant but rather a user who is interested in the survey results. For example, the second user may be a decision maker such as a manager who may make decisions that involve and/or affect the first user and/or other survey participants.

In some embodiments, the activity information may include information associated with training classes. In some embodiments, the activity information may include information associated with team building activities such as retreats, lunches, company sports, etc. In some embodiments, the activity information may include information associated with recreational activities team outings, hikes, etc. In some embodiments, the activity information may include information associated with an employee receiving a work evaluation, a compensation increase, promotions, awards and other recognition, etc.

In various embodiments, such activities and associated information are stored in one more internal and/or external data stores. In various embodiments, for the activity information, the system may collect and store the nature of each activity (e.g., training, retreat, award, etc.). The activity information that the system collects and stores may vary, depending on the particular implementation. For example, in some embodiments, the system may collect and store the department, group, or team that participated each activity. The system may collect and store the department, group, or team that participated each activity. The system may collect and store people who facilitated each activity (e.g., trainers, etc.).

In some embodiments, the system determines at least some of the activity information based at least in part on one or more data sources. In various embodiments, the activity information may be stored and retrieved from one or more data sources. For example, a user activity engine of the system may be integrated with several internal and external systems. Such systems may include databases, social networks, etc., which identify and/or store activities taken by each user and also for each group of users. Such a group may include users of a social network, members of an organization or company, etc. Also, the system may group people based on different demographics (e.g., woman, men, job title, team, department, etc.).

In some embodiments, the activity information includes activity patterns associated with the first user. For example, the user may be involved with multiple activities (e.g., multiple training classes in different topics, etc.). In various embodiments, the system may determine patterns and trends in such activities and associated information (e.g., frequency of activities, etc.) and such information may be stored in one more internal and/or external data stores. The patterns and trends that the system collects and stores may vary, depending on the particular implementation. For example, in some embodiments, the system may track any activities related human resource information, work evaluation information, compensation information, work project information, leave information, recognition and award information, etc.

At block 204, the system generates one or more survey questions based at least in part on the activity information. For example, in some embodiments, the system may generate one or more of the survey questions based at least in part on the activity patterns associated with the first user. In various embodiments, the system may utilize a user trend traversal (UTT) engine to map questions on the survey with user activities using deep analytical logic. Based on the mappings, the system correlates each question with one or more user activities.

In indicated above, the system may determine not only general activity information but also determine patterns and trends associated with activities. The system may determine and track activity patterns and trends for a single individual. The system may also determine and track activity patterns and trends in aggregate for a group of people. In various embodiments, survey questions may or may not be generated by using user activity. For example, as described below, the system may use preexisting survey questions to generate a survey.

At block 206, the system retrieves survey questions from one or more existing survey systems. Such survey systems may include one or more databases that contain preexisting survey questions. The system may include survey questions stored at any combination of existing survey systems.

At block 208, the system provides the survey to the first user, where the first user is a survey participant. The survey includes the survey questions for the first user to answer. In other words, the first user/survey participant provides survey answers in response to the survey questions. As indicated herein, the survey and its associated survey questions are delivered to the user electronically. The survey may be presented to the user via a user interface shown in the browser of a client device, for example.

At block 210, the system receives survey answers from the first user, where the survey answers are responsive to the survey questions. In various embodiments, the system may provide fields, check boxes, multiple-choice, etc., where the survey participant may enter an answer or select an answer. The client device may then send survey answers to the system.

In some implementations, the system determines at least some of the activity information based on the survey. For example, in some scenarios, the system may prompt the user with a question directed to current or past activities of the user. As such, the user may enter activities or select activities from a selection of activities. The system may store and/or add such activities to an existing list of activities associated with the user.

At block 212, the system determines a sentiment score based at least in part on the survey answers provided by the first user. In various embodiments, the system may generate and include in the survey one or more questions asking how the user feels about a particular issue. For example, the system may prompt the user to give an opinion about management, about the user's team, about the user's department, about the user's job, about the user's career direction, about a particular activity such as a training class, etc. For example, suppose there is a question on the survey, “My job performance has been evaluated fairly.” For this question, presume some users have responded, “Strongly agree,” and some users have responded, “Strongly disagree.” In some embodiments the UTT engine of the system may analyse the responses by fetching the user activity from one or more different internal systems such as a human resource management system (HRMS) or other database source. The system detects patterns such as determining which users have been involved with specific activities (e.g., specific work projects, outings, training classes, etc.) and who have responded positively for the question. The system may also detect patterns such as determining which users have not been involved in particular activities and who have responded negatively for the question.

In various embodiments, the system may group users into particular categories. For example, the system may tag users based on their department, team, location, job title, pay scale, education, gender, age, etc. Such categories enables the system to correlate individuals and groups with activities and to correlate individuals and groups to trends to sentiment scores. For example, the system may determine that younger employees in a particular department generally respond more positively to training. The system may determine that managers respond more positively to team building activities. The system may determine that most people respond more positively to a particular training class, yet most people respond more negatively to particular trainers.

In various embodiments, the system may aggregate answers from the user to determine a sentiment score. There may be multiple sentiment scores. For example, one sentiment score may be directed to an organization in general, where survey answers may be associated with management, the department, etc. are aggregated. In another example, one sentiment score may be directed more specifically to a user's career.

At block 214, the system associates the activity information with the sentiment score. For example, the system may first determine if the sentiment score or sentiment scores are positive, neutral, or negative. Such a determination of a given sentiment score may be a simple as two states (e.g., positive or neutral) or three states (e.g., positive, neutral, or negative). In some embodiments, a given sentiment score may be a number (e.g., from 0.0 to 1.0, where 0.0 is negative, 0.5 is neutral, and 1.0 is positive).

The system may then associate the sentiment score with an activity. In some embodiments, if there are multiple sentiment scores, the system may associate each sentiment score with a particular activity. As indicated herein, in various embodiments, the system derives one or more questions from each activity. As such, the system already has associated with activities with one more or survey questions. In various embodiments, the system associates the activity information with the sentiment score or scores associated with those survey questions. As such, the system determines correlations between sentiment scores and activities based at least in part on the survey questions.

At block 216, the system generates a recommendation for a second user based at least in part on the activity information and the sentiment score. In some embodiments, the second user may be a manager, for example, where the recommendation assists the manager in making decisions.

In various embodiments, the system generates the recommendation based on an analysis of the survey results (e.g., answers to survey questions). For example, as indicated above, the system determines correlations between sentiment scores and activities based on the survey results. The system may employ various association-mining techniques for different clusters of sentiment scores and activities. For example, the system may map positive sentiment scores (e.g., one or more answers to survey questions indicating happiness, satisfaction, etc., with a particular activity (e.g., team retreat). Conversely, the system may map negative sentiment scores (e.g., one or more answers to survey questions indicating frustration, dissatisfaction, etc., with a particular activity (e.g., class or workshop with a particular facilitator) or lack thereof (e.g. no training classes being provided to a particular team or department). The system then defines optimal sets of correlated sentiment scores and activities.

The system then derives one or more recommendations for the second user. Such recommendations may include, for example, one or more corrective actions. In some embodiments, a corrective action may include one or more activity suggestions. For example, a corrective action may include providing training classes for the user and/or the user's team or department.

In various embodiments, the system may transmit the recommendation to one or more recipient users (e.g., manager, facilitator, etc.) using various technologies such as mobile application, web applications, etc. The particular reporting methods may vary, and will depend on the particular implementation. For example, the system may also transmit the recommendation to one or more recipient via any cloud based model, on-prime model, peer-peer channels, etc. A given recipient user may receive one or more recommendations via any suitable device (e.g., desktop computer, laptop computer, tablet, smartphone, etc.).

In some embodiments, the system may generate multiple recommendations, where each recommendation corresponds to a particular aspect or set of questions. For example, a recommendation may be direct to maintaining or increasing positive sentiment. Another recommendation may be direct to decreasing or eliminating negative sentiment. Further example embodiments directed to recommendations are described in more detail herein.

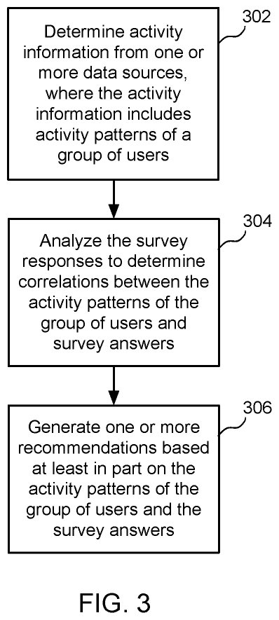

FIG. 3 is an example flow diagram for generating a recommendation based on survey results, according to some embodiments. As described above, the system analyses survey results in order to provide insight to decision makers (e.g., managers, etc.) who make decisions that affect with their employees, for example. The flow diagram of FIG. 3 provides further example embodiments directed to the analysis of survey results and resulting recommendation(s).

In some embodiments, a method begins at block 302, where a system such as system 102 determines activity information associated with different user of a group of users. In some embodiments, the system may use the UTT engine to determine activity patterns and to determine recommendations for decision makers in an organisation, a governing body, a sub-population, etc.

In various embodiments, the UTT engine of the system gathers all of the activity information associated with a user/survey participant. As indicated herein, the system may access such activity information (e.g., training, work projects, etc.) from an HRMS or other data source. The UTT engine forms one or more groupings out of the survey population to categorize the survey participants and their responses to the survey questions. Such groupings may include categories of people based on department, team, location, gender, etc., or any combination thereof.

As indicated herein, the activity information may be stored and retrieved from one or more data sources. In various embodiments, the activity information includes activity patterns from a group of users, where one or more of the survey participants belong to the group of users. In various embodiments, the UTT engine may perform cognitive analysis techniques to identify additional activities of a given user or group of users from ongoing survey answers, as well as from external data sources when updated.

At block 304, the system analyzes the survey responses to determine if there are any correlations between the activities of the group of users and one or more of the survey answers. The survey responses include survey answers from each user/survey participant in response to the survey questions. In various embodiments, the system may use the UTT engine to determine characteristics of each of the users of the group and to find correlations between characteristics of a group (e.g., location, activities, etc.) and survey answers.

In various embodiments, the system determines correlations between activity patterns of the group of users and the survey answers. For example, the system may determine if certain users answered certain questions in a particular way (e.g., satisfied with one's job). The system may also determine that the users who answered in the same way have participated in the same activities (e.g., a particular training class). As such, the system may determine that there is a correlation between a particular activity pattern among the users (e.g., all have taken a particular training class, etc.) and survey answers (e.g., all are satisfied with their jobs).

In an example scenario, the system may determine patterns such as people in a particular location (e.g., Delhi) have positively responded a particular survey question indicating employee engagement scores are “high.” The system may also determine patterns such that the training class that occurred in the particular location (e.g., Delhi) has a positive impact on employees' thinking and sentiment, which resulted in positive responses to survey questions.

In an example scenario, the system may determine patterns such as people in another particular location (e.g., Mumbai) have negatively responded a particular survey question indicating employee engagement scores are “low.” The system may also determine patterns indicating that no training classes have occurred in the particular location (e.g., Mumbai), which has a negative impact on employees' thinking and sentiment, which resulted in negative responses to survey questions.

The system may compare the survey results of different locations (e.g., Delhi versus Mumbai), and determine that conducting training classes may yield positive responses to some survey questions and also determine that not conducting training classes may yield negative responses to some survey questions.

At block 306, the system generates one or more recommendations based at least in part on the activity patterns of the group of users and one or more of the survey answers. In the example scenarios above, the system may generate a recommendation based on an activity pattern of certain users one group having taken a particular training class and the other group not having taken a training class, and based on their differing answers to one or more survey questions in the same way. As such, the recommendation may be to continue providing training classes in Delhi and to provide training classes in Mumbai.

In another example scenario, the system may determine a pattern that particular training class (e.g., Python) occurred in a particular location (e.g., Kolkata), but that users in that group from Kolkata produced negative survey answers. The system may determine that the particular trainer for that class was not a good fit for the group of users. Such a determination may be derived from one or more particular survey questions (e.g., survey questions directed to the trainer). In some implementations, the system may also group users based on various properties. For example, in some implementations, the system may group users in subgroups, which may be based on one or more predetermined demographics (e.g., gender, age group, work profile, location, and/or combinations thereof, etc.). The system may determine patterns on positive or negative survey responses to particular subgroups.

In various embodiments, the system may make one or more recommendations to one or more users who are decision makers (e.g., management, survey initiator, etc.). In some embodiments, one of the recommendations may include an action plan. The action plan may be, for example, scheduling a training class for a particular group within a predetermined time frame (e.g., within 2 months, etc.).

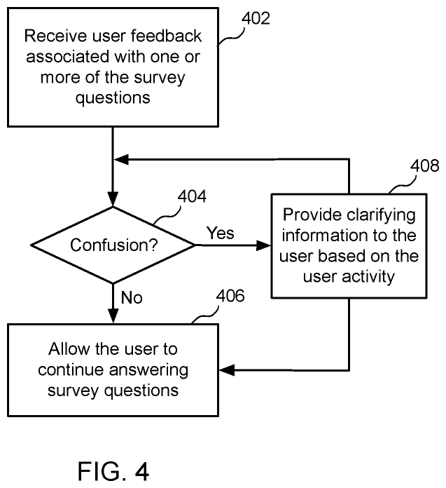

FIG. 4 is an example flow diagram for improving a survey taking experience, according to some embodiments. The flow diagram of FIG. 4 provides example embodiments directed to the system improving of survey results by providing explanatory remarks to the survey participant based on particular issues (e.g., confusion) that the survey participant may have while taking the survey. As indicated herein, while some embodiments are described herein in the context of a single user/survey participant, such embodiments also apply to multiple users, or each survey participant.

In some embodiments, a method begins at block 402, where a system receives user feedback from the user/survey participant, where the user feedback is associated with one or more of the survey questions. In various embodiments, such user feedback occurs while the user is providing survey answers in response to survey questions in the survey. The system may determine user feedback for any number of survey questions up to each and every question, depending on the situation.

At block 404, the system determines if there is any confusion on the part of the user. In some embodiments, the system may detect user feedback based on manual feedback. For example, the system may enable the user to select a portion of the survey question and provide user feedback on those survey questions. The user feedback may include, for example, the user's opinion on one or more survey questions. For example, in some embodiments, the system may provide selection buttons indicating for each question if the user is confused by the question and/or needs clarification. The user clicking on the button may indicate confusion.

In some embodiments, the system may detect user feedback based on a predetermined time that it takes for the user to answer a survey questions. For example, an unusual delay (e.g., 45 seconds, 60 seconds, etc.) may indicate that the user is confused about the current question.

In some embodiments, the system may detect user feedback based on user gestures. For example, the system may detect a facial expression using a camera, where the facial expression indicates confusion.

In some embodiments, the system may log instances of detected confusion, including information on the question and whether the user answered the question after clarification. The system may provide such information to the non-respondent user as a part of the analysis of the survey results. Such information may be useful for designing future surveys, and may be used to tailor such future surveys for particular survey participant users or groups of users.

At block 406, the system allows the user to continue answering survey questions, if a system determines that there is no confusion on the part of the user.

At block 408, the system provides clarifying information to the first user based on the user activity, if a system determines that there is confusion on the part of the user. In some embodiments, if the system continues to determine that there is confusion at block 404 on the part of the user, the system may continue to provide clarifying information at block 408. Alternatively, in some embodiments, after the system provides clarifying information at block 408, the system may proceed to allow the user to continue answering survey questions at block 406. In various embodiments, the UTT engine maps each survey question with one or more user activities after concluding that the user is confused. For example, presume a survey question asks, “How did you like the training?” The system may receive feedback that user is confused by the question. For example, the user may manually select a button indicating confusion, or the user may take an unusually long time to answer the question. In various embodiments, the system maps key words in the question (e.g., training, etc.) to one or more activities (e.g., training events, etc.). The system also determines that the user had participated in a particular class included in the mapped training activities (e.g., Java training, etc.). As such, the system may display the Java training class and possibly other related information (e.g., date and location, etc.) to the user. Such context may refresh the memory of the user and/or clarify what specific activity the question is referring to. As a result, the user has a better understanding of the question and can better or more accurately answer the question. In various embodiments, the same survey may be given to multiple users on different teams, locations, etc. As such, the same general question (e.g., associated with training, etc.) may be relevant to multiple users even if each user participated in different activities.

The system allows the user to continue answering survey questions at block 406 when the system determines that there is no longer confusion on the part of the user at block 404. For example, the user manually selecting a button indicating that the user understands the survey question indicates that there is no longer confusion with that question. In another example, the user proceeding to answer the survey question indicating that the user understands the survey question indicates that there is no longer confusion with that question.

In an example scenario, a survey question may ask, for example, “How do you feel about your last work-related event?” The survey answers may included, “Very Satisfied,” “Satisfied,” “Neutral,” “Unsatisfied,” and “Very Unsatisfied.” The user might not understand the survey question, which the user may indicate based on one or more techniques described above (e.g., manual indication, delay, gesture, etc.). The system may map the survey question to the particular activity. The system may then provide clarifying information that indicates the particular context (e.g., indicate the specific work-related event). For example, the system may display, “This question refers to the Python training class that occurred in your location earlier this year.” This may help the user to understand the context of the survey question posed and to then answer the survey question.

As a result, the system generates and provides surveys that help a non-respondent user (e.g., manager, survey organizer, etc.) to improve a survey, improve the response rate of a survey, better understand survey participants, etc.

Embodiments described herein provide various benefits. For example, embodiments provide deep analysis of survey results and facilitates in the understanding of thought patterns of survey respondents. Embodiments also enable the tailoring a survey to a particular user based on the user's ongoing activities. Embodiments also allow for user feedback on questions in order for the system to provide clarification for any confusion while a user answers survey questions.

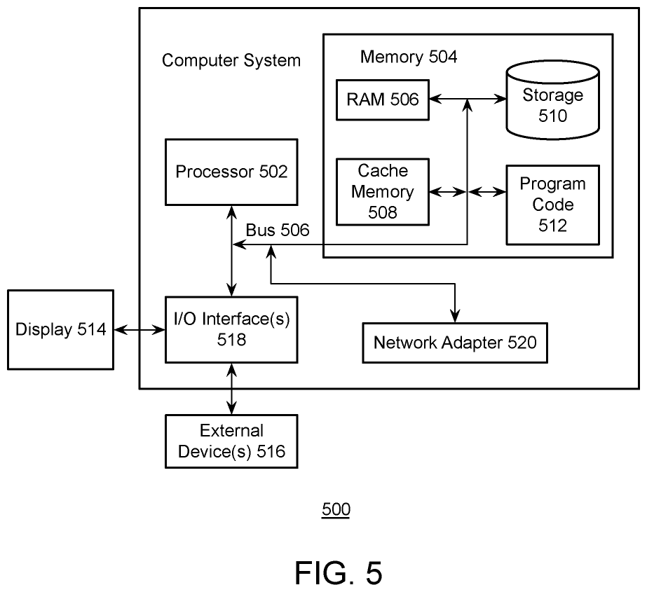

FIG. 5 is a block diagram of an example computer system 500, which may be used for embodiments described herein. For example, computer system 400 may be used to implement server device 104 of FIG. 1, as well as to perform embodiments described herein. Computer system 500 is operationally coupled to one or more processing units such as processor 502, a memory 504, and a bus 506 that couples to various system components, including processor 502 and memory 504. Bus 506 represents one or more of any of several types of bus structures, including a memory bus, a memory controller, a peripheral bus, an accelerated graphics port, a processor or local bus using any of a variety of bus architectures, etc. Memory 504 may include computer readable media in the form of volatile memory, such as a random access memory (RAM) 506, a cache memory 508, and a storage unit 510, which may include non-volatile storage media or other types of memory. Memory 504 may include at least one program product having a set of at least one program code module such as program code 512 that are configured to carry out the functions of embodiments described herein when executed by processor 502. Computer system 500 may also communicate with a display 514 or one or more other external devices 516 via input/output (I/O) interface(s) 518. Computer system 500 may also communicate with one or more networks via network adapter 520. In other implementations, computer system 500 may not have all of the components shown and/or may have other elements including other types of elements instead of, or in addition to, those shown herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising:
at least one processor and a computer readable storage medium having program instructions embodied therewith, the program instructions executable by the at least one processor to cause the at least one processor to perform operations comprising:
determining activity information associated with a first user;
providing a survey to the first user, wherein the first user is a survey participant, and wherein the survey includes a plurality of survey questions for the first user to answer;
receiving a plurality of survey answers from the first user, wherein the plurality of survey answers is responsive to the plurality of survey questions;
determining a sentiment score based at least in part on the plurality of survey answers provided by the first user;
associating the activity information with the sentiment score; and
generating a recommendation for a second user based at least in part on the activity information and the sentiment score.

2. The system of claim 1, wherein the activity information comprises one or more of training classes, team outings, receiving of compensation increases, promotions, and awards.

3. The system of claim 1, wherein the at least one processor further performs operations comprising determining at least some of the activity information based at least in part on one or more data sources.

4. The system of claim 1, wherein the at least one processor further performs operations comprising determining at least some of the activity information based at least in part on one or more data sources, wherein the activity information comprises activity patterns associated with the first user.

5. The system of claim 1, wherein the at least one processor further performs operations comprising determining at least some of the activity information based on the survey.

6. The system of claim 1, wherein the at least one processor further performs operations comprising:
determining activity information from one or more data sources, wherein the activity information comprises activity patterns from a group of users, and wherein the first user belongs to the group of users; and
generating the recommendation based at least in part on the activity patterns of the group of users and the survey answers.

7. The system of claim 1, wherein the at least one processor further performs operations comprising:
receiving user feedback from the first user, wherein the user feedback is associated with one or more of the survey questions; and
providing clarifying information to the first user based on the user feedback.

8. A computer program product comprising a computer readable storage medium having program instructions embodied therewith, the program instructions executable by at least one processor to cause the at least one processor to perform operations comprising:
determining activity information associated with a first user;
providing a survey to the first user, wherein the first user is a survey participant, and wherein the survey includes a plurality of survey questions for the first user to answer;
receiving a plurality of survey answers from the first user, wherein the plurality of survey answers is responsive to the plurality of survey questions;
determining a sentiment score based at least in part on the plurality of survey answers provided by the first user;
associating the activity information with the sentiment score; and
generating a recommendation for a second user based at least in part on the activity information and the sentiment score.

9. The computer program product of claim 8, wherein the activity information comprises one or more of training classes, team outings, receiving of compensation increases, promotions, and awards.

10. The computer program product of claim 8, wherein the at least one processor further performs operations comprising determining at least some of the activity information based at least in part on one or more data sources.

11. The computer program product of claim 8, wherein the at least one processor further performs operations comprising determining at least some of the activity information based at least in part on one or more data sources, wherein the activity information comprises activity patterns associated with the first user.

12. The computer program product of claim 8, wherein the at least one processor further performs operations comprising determining at least some of the activity information based on the survey.

13. The computer program product of claim 8, wherein the at least one processor further performs operations comprising:
determining activity information from one or more data sources, wherein the activity information comprises activity patterns from a group of users, and wherein the first user belongs to the group of users; and
generating the recommendation based at least in part on the activity patterns of the group of users and the survey answers.

14. The computer program product of claim 8, wherein the at least one processor further performs operations comprising:
receiving user feedback from the first user, wherein the user feedback is associated with one or more of the survey questions; and
providing clarifying information to the first user based on the user feedback.

15. A computer-implemented method for conducting and analyzing electronic surveys, the method comprising:
determining activity information associated with a first user;
providing a survey to the first user, wherein the first user is a survey participant, and wherein the survey includes a plurality of survey questions for the first user to answer;
receiving a plurality of survey answers from the first user, wherein the plurality of survey answers is responsive to the plurality of survey questions;
determining a sentiment score based at least in part on the plurality of survey answers provided by the first user;
associating the activity information with the sentiment score; and
generating a recommendation for a second user based at least in part on the activity information and the sentiment score.

16. The method of claim 15, wherein the activity information comprises one or more of training classes, team outings, receiving of compensation increases, promotions, and awards.

17. The method of claim 15, wherein the at least one processor further performs operations comprising determining at least some of the activity information based at least in part on one or more data sources.

18. The method of claim 15, wherein the at least one processor further performs operations comprising determining at least some of the activity information based at least in part on one or more data sources, wherein the activity information comprises activity patterns associated with the first user.

19. The method of claim 15, wherein the at least one processor further performs operations comprising determining at least some of the activity information based on the survey.

20. The method of claim 15, wherein the at least one processor further performs operations comprising:
determining activity information from one or more data sources, wherein the activity information comprises activity patterns from a group of users, and wherein the first user belongs to the group of users; and
generating the recommendation based at least in part on the activity patterns of the group of users and the survey answers.
